(19) United States
(12) Patent Application Publication
(10) Pub. No.: US 2011/0195731 A1
(43) Pub. Date: Aug. 11, 2011

(54) METHOD AND APPARATUS FOR UPLINK INTERFERENCE CANCELLATION IN WIRELESS MOBILE COMMUNICATION SYSTEM

(75) Inventors: Yun-Jik JANG, Seoul (KR); Seung-Hyun MIN, Seoul (KR); Seung-Joo MAENG, Seongnam-si (KR); Tai-Suk KIM, Seoul (KR)

(73) Assignee: SAMSUNG ELECTRONICS CO. LTD., Suwon-si (KR)

(21) Appl. No.: 12/954,769

(22) Filed: Nov. 26, 2010

(30) Foreign Application Priority Data
Feb. 5, 2010 (KR) 10-2010-0010750

(51) Int. Cl. H04B 15/00

(52) U.S. Cl. 455/501

(57) ABSTRACT

An apparatus of a Base Station (BS) and a method for cancelling uplink interference in a wireless mobile communication system are provided. The method includes estimating interference to be exerted by each User Equipment (UE) on a plurality of neighbor cells based on a Rise over Thermal (RoT) level for the plurality of the neighbor cells, determining a transmit power change for each UE based on the estimated interference to be exerted on the neighbor cells, and transmitting the transmit power change for the UE to each UE. The cell coverage is maintained by maintaining the interference exerted on the neighbor cell at a proper level, and the average data rate is enhanced.

### PRIORITY

This application claims the benefit under 35 U.S.C. §119(a) of a Korean patent application filed in the Korean Intellectual Property Office on Feb. 5, 2010, and assigned Serial No. 10-2010-0010750, the entire disclosure of which is hereby incorporated by reference.

### BACKGROUND OF THE INVENTION

1. Field of the Invention

The present invention relates to an uplink interference cancellation method of a wireless mobile communication system. More particularly, the present invention relates to a method and an apparatus for determining a transmit power of User Equipments (UEs) in uplink interference cancellation of a wireless mobile communication system.

2. Description of the Related Art

In conventional wireless mobile communication systems, for example, Code Division Multiple Access (CDMA) communication systems, every User Equipment (UE) transmits constant data based on a circuit transmission scheme and the system only has to determine a data rate of each UE. To determine the data rate of each UE, the data rate of every UE in the cell is increased or decreased all together according to its own cell interference, other cell interference, and Rise over Thermal (RoT) magnitude of thermal noise in the cell. That is, by keeping the RoT value of each cell at a constant level, constant coverage of the cell is sustained and each UE maintains the data rate over a certain level. The RoT is defined as a ratio of power received from every UE at a base station to the thermal noise.

An advanced wireless communication system such as Long Term Evolution (LTE) system, supports a function for informing of a magnitude of an uplink cell interference from one cell to another cell, analyzes downlink signals from not only a serving cell of the UE but also a neighbor cell, determines downlink path losses of the serving cell and the neighbor cells, and transmits the determined downlink path losses to the base station. Based on the downlink path loss information, the base station can control handoff and cancel other cell interference of the UE.

Meanwhile, unlike the conventional wireless mobile communication systems, the advanced mobile communication system such as the LTE system, adopts an Orthogonal Frequency Division Multiplexing (OFDM) transmission scheme. Accordingly, the own cell interference does not occur as in a Code Division Multiple Access (CDMA) system and only the other cell interference takes place. In more detail, since the CDMA system distinguishes channels with codes in the same frequency band, the own cell interference and the other cell interference are present. In contrast, the OFDM system, which distinguishes channels with subcarriers, incurs only the other cell interference. Hence, it is impossible to apply a method for cancelling the own cell interference by adjusting the data rate of the UE and for maintaining the constant RoT of each cell by cancelling the own cell interference, as in the conventional mobile communication systems.

Therefore, a need exists for an apparatus and a method for maintaining a RoT ratio of each cell below a certain level in an advanced mobile communication system.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for cancelling uplink interference in a wireless mobile communication system.

Another aspect of the present invention is to provide a method and an apparatus for maintaining interference exerted on an uplink neighbor cell below a certain level by determining an uplink UE transmit power in an LTE system.

Yet another aspect of the present invention is to provide a method and an apparatus for enhancing uplink performance by maintaining interference exerted by a UE of each cell onto other cells below a certain level based on an uplink transmit power in an LTE system.

In accordance with an aspect of the present invention, a method for cancelling uplink interference in a wireless mobile communication system is provided. The method includes estimating interference to be exerted by each User Equipment (UE) on a plurality of neighbor cells based on a Rise over Thermal (RoT) level for the plurality of the neighbor cells, determining a transmit power change for each UE based on the estimated interference to be exerted on the neighbor cells, and transmitting the transmit power change for the UE to each UE.

In accordance with another aspect of the present invention, an apparatus of a Base Station (BS) for cancelling uplink interference in a wireless mobile communication system is provided. The apparatus includes the BS for estimating interference to be exerted by UEs on a plurality of neighbor cells based on an RoT level for the plurality of the neighbor cells, for determining a transmit power change for each UE based on the estimated interference to be exerted on the plurality of the neighbor cells, and for transmitting the transmit power change for the UE to each UE.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart for determining a transmit power change of a User Equipment (UE) to cancel uplink interference in a wireless mobile communication system according to an exemplary embodiment of the present invention;

FIG. 2 is a flowchart for determining Ol_Weight_dB using a Rise over Thermal RoT value received from a neighbor base station in a wireless mobile communication system according to an exemplary embodiment of the present invention;

FIG. 3 is a flowchart for determining a neighbor cell around a base station using neighbor cell downlink path loss information reported from a UE in a wireless mobile communication system according to an exemplary embodiment of the present invention;

FIG. 4 is a flowchart for determining a path loss between a corresponding UE and a neighbor cell using a neighbor cell list formed based on neighbor cell downlink path loss information reported by the UE in a wireless mobile communication system according to an exemplary embodiment of the present invention;

FIG. 5 is a flowchart for limiting a transmit power change according to a Modulation and Coding Scheme (MCS) level of a UE in a wireless mobile communication system according to an exemplary embodiment of the present invention;

FIG. 6 is a flowchart for determining a transmit power change according to IoT_MetricdB of a UE in a wireless mobile communication system according to an exemplary embodiment of the present invention;

FIG. 7 is a flowchart for limiting a transmit power change of a UE according to a resource use rate of a base station in a wireless mobile communication system according to an exemplary embodiment of the present invention;

FIG. 8 is a flowchart for determining a UE transmit power change command according to a cumulative value of the transmit power change of the UE in a wireless mobile communication system according to an exemplary embodiment of the present invention; and

FIG. 9 is a block diagram of a base station for cancelling an uplink interference by determining a transmit power change of a UE in a wireless mobile communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method and an apparatus for maintaining interference exerted on an uplink neighbor cell below a certain level by determining an uplink User Equipment (UE) transmit power in a Long Term Evolution (LTE) system. Hereinafter, while the LTE system is exemplified, the present invention is not limited to the LTE system but applicable to Orthogonal Frequency Division Multiplexing (OFDM)/Orthogonal Frequency Division Multiple Access (OFDMA), such as Institute of Electrical and Electronics Engineers (IEEE) 802.16 standard, based systems.

In the LTE system, a transmit power of a general UE is determined based on equation 1.

P_{PUSCH}(i)=10 log₁₀(M_{PUSCH}(i))+P_{O}_{_{—}}_{PUSCH}(j)+α(j)PL+Δ_{TF}(i)+f(i) (1)

In equation 1, PL denotes a path loss between a serving Base Station (BS) and the UE, which is measured by the UE and reported to the serving BS, α(j) denotes a rate for compensating the path loss PL, P_{O}_{_{—}}_{PUSCH} (j) denotes a reference receive power defined by the BS, Δ_{TF}(j) denotes an offset based on a Modulation and Coding Scheme (MCS) level of a data packet scheduled, f(i) denotes a transmit power change cumulative value, and M_{PUSCH}(i) denotes a size of a packet transmitted by the UE. Also, i denotes a UE index and j denotes a BS index.

The BS transmits α(j), P_{O}_{_{—}}_{PUSCH}(j), and Δ_{TF}(j) to the UE as system parameters, defines f(i)=0 to perform only open-loop power control when the transmit power of the UE is not adjusted, and performs closed-loop power control when the BS adjusts f (i) of the UE using various information. In the LTE system, when transmitting scheduling information to the UE, the BS may change the transmit power of the UE by commanding to the UE. The UE may accumulate and manage the transmit power change value, or may not use the transmit power change value recently received from the BS without accumulating it.

It is assumed that the UE accumulates and manages the transmit power change value f(i) received from the BS. It is also assumed that Δ_{TF}(j) is set to zero all the time so that the transmit power does not vary according to the MCS level of the packet transmitted from the UE. The α(j) and P_{O}_{_{—}}_{PUSCH}(j) set values do not affect the exemplary embodiments of the present invention.

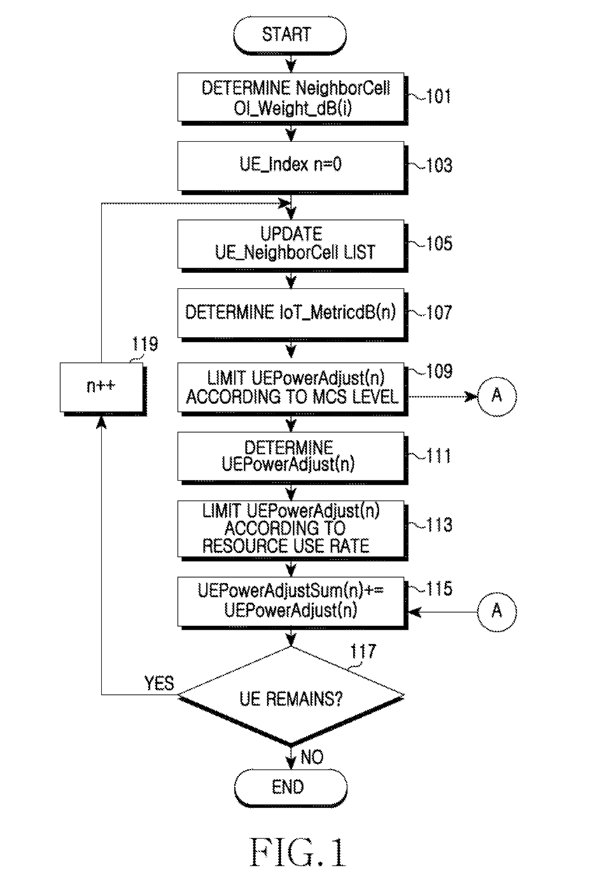

FIG. 1 is a flowchart for determining a transmit power change of a UE to cancel uplink interference in a wireless mobile communication system according to an exemplary embodiment of the present invention.

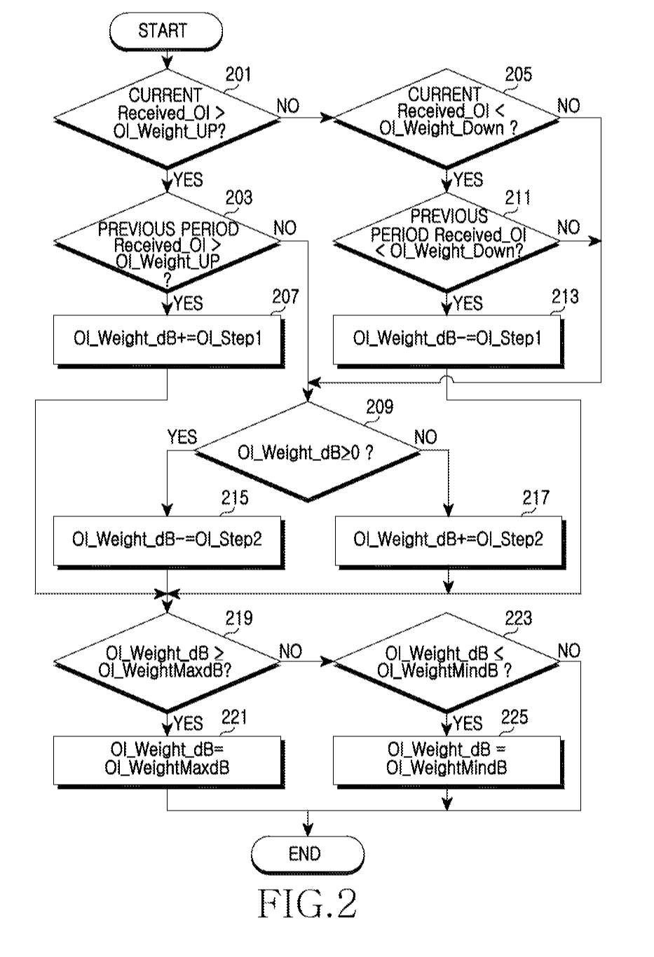

Referring to FIG. 1, in step 101, the BS receives a Rise over Thermal (RoT) value of the neighbor cells, and updates the RoT value (i.e., Ol_Weight_dB) of the neighbor cells by comparing the RoT value of the neighbor cells with a RoT value of previous neighbor cells. That is, the BS sets the value Ol_Weight_dB(i) to apply to the neighbor cell i in step 101. The neighbor cell i is an index of the neighbor cell and Ol_Weight_dB(i) is set and managed per BS. A process for determining Ol_Weight_dB(i) shall be elucidated in more detail with reference to FIG. 2.

In step 103, the BS sets a UE index UE_Index=0.

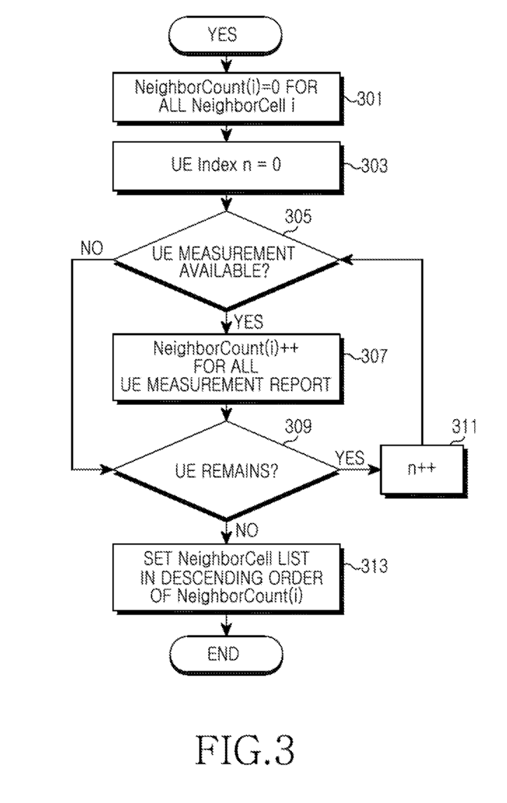

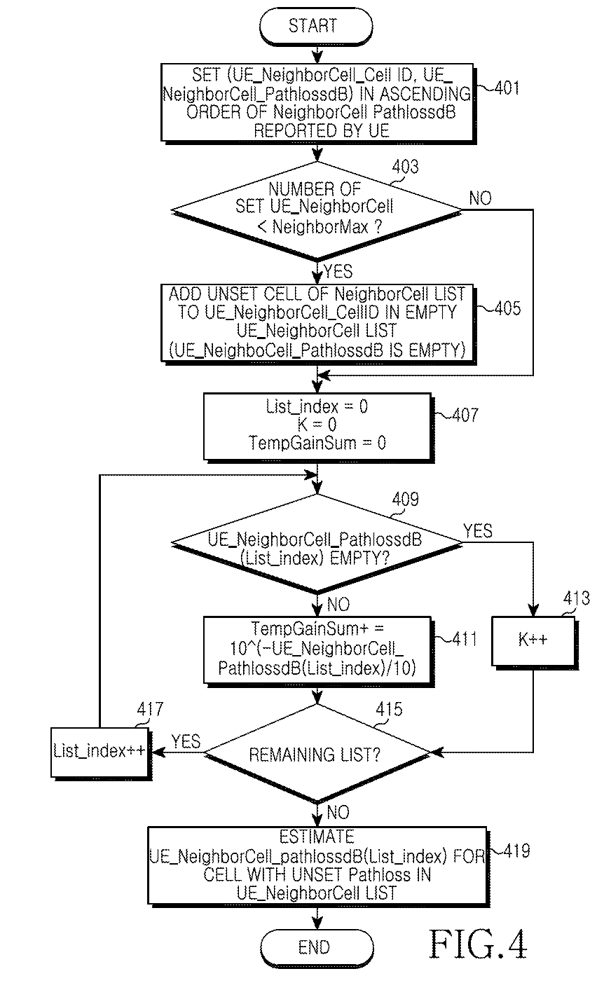

In step 105, the BS updates a neighbor cell list UE_NeighborCell(n) of each UE using the downlink path loss value reported from each UE. In more detail, each UE measures the downlink path loss of not only its serving BS but also the neighbor BS, and reports the measured downlink path loss to the BS. Using the downlink path loss information, the BS manages the neighbor cell list UE_NeighborCell(n) for each UE. Using the neighbor cell downlink path loss measurement information reported by the corresponding UE and a downlink Channel Quality Indicator (CQI), the neighbor cell list stores a neighbor cell index expected to exert considerable uplink interference of each UE, and the uplink path loss to the corresponding cell. The updating of the neighbor cell list UE_NeighborCell(n) is described in more detail with reference to FIGS. 3 and 4.

In step 107, using the neighbor downlink path loss information of each UE stored to the UE_NeighborCell(n), the BS estimates an interference exerted by each UE to the neighbor cell and determines a difference (i.e., IoT_MetricdB(n)) between the estimated interference and a target interference of the BS. When the IoT_MetricdB(n) is greater than 0 dB, the BS determines that the corresponding UE exerts the interference greater than the target to the neighbor cell. Conversely, when the IoT_MetricdB(n) is less than 0 dB, the BS determines that the corresponding UE exerts the interference less than the target on the neighbor cell.

Upon setting the neighbor cell list UE_NeighborCell list of each UE, the BS determines the IoT_MetricdB indicating the magnitude of the interference exerted by the corresponding UE on the neighbor cell based on equation 2.

$$\begin{matrix}IoT\_MetricdB ( n ) = {( {\sum }_{i}^{for all UE NeighborCell} {( IoT\_MetricdB ( n , i ) )}_{linear} )}_{d B} & ( 2 ) \\ IoT\_MetricdB ( n , i ) = OI\_WeightdB ( i ) + CurrentTxP owerdBm ( n ) - ( RBNo + 10 \times {log}_{10} ( {10}^{( IoTTarg etdB / 10 )} - 1 ) ) + CINRfactor \times CINRdB ( n ) - NeighborPathlossdB ( n , i ) & ( 3 )\end{matrix}$$

To determine the IoT_MetricdB(n) of the UE n, the BS obtains a linear sum by determining a relative value IoT_MetricdB(n,i) which compares the interference magnitude from the UE to the neighbor cell i with the target IoT, and then converts the linear sum to the dB. The IoT_MetricdB(n,i) is determined in equation 4.

Herein, the Ol_Weight_dB(i) is the dB scale value managed by the BS based on the RoT information received from the neighbor cell as described in step 101 of FIG. 1. In equation 4, CurrentTxPowerdBm(n) denotes a transmit power per resource of each UE. In the LTE system, CurrentTxPowerdBm(n) indicates the power transmitted from the UE per Resource Block (RB). RBNo denotes the power magnitude of the thermal noise per resource. In the LTE system, RBNo indicates the magnitude of the thermal noise per RB. IoTT arg etdB denotes the target interference in the system. In general, Interference over Thermal (IoT) ratio or RoT ratio value is

$$\frac{Noiser + Interference}{Noise} .$$

The greater an interference magnitude, the greater the IoT value. The BS sets the IoTT arg etdB by determining the target IoT using the target interference magnitude of the system and converting to the dB. Also, in equation 4, CINRdB(n) denotes a Carrier-to-Interference-and-Noise Ratio (CINR) value received from the BS when the UE transmits a data packet, and is reported by the UE to the BS. CINRfactor denotes a constant value indicating the rate of applying CINRdB(n) to IoT_MetricdB(n,i), and NeighborPathlossdB(n,i) denotes the path loss of the UE n and the neighbor cell i and is provided from the neighbor cell list UE_NeighborCell list.

In step 111, the BS determines a UE transmit power change UEPowerAdjust(n) using the determined IoT_MetricdB(n). Based on the UEPowerAdjust(n), the transmit power of the UE is increased or decreased.

In step 113, the BS determines UEPowerAdjustSum(n) by accumulating the UEPowerAdjust(n). The period of the BS for scheduling the data packet and transmitting a command to adjust the transmit power of the UE to each UE may not match a period for determining the transmit power change of the UE for the interference cancellation. That is, even when the BS determines the change of the transmit power of the UE, the power control command may not be transmitted to the UE immediately. Thus, when the UE transmit power change period arrives, the BS determines and accumulates the transmit power UEPowerAdjust(n) of each UE, and thus manages UEPowerAdjustSum(n) in step 115. When the command instructing to adjust the transmit power is transmitted to the UE, the BS manages the transmit power by subtracting the change commanded to the UE from the UEPowerAdjustSum(n) in step 115. In step 117, the BS determines whether there remains the UE which will report the downlink information of the serving cell and the neighbor cell. If it is determined that the UE which will report the downlink information of the serving cell and the neighbor cell remains, the BS increases the value n by one in step 119 and performs step 105 for a next UE.

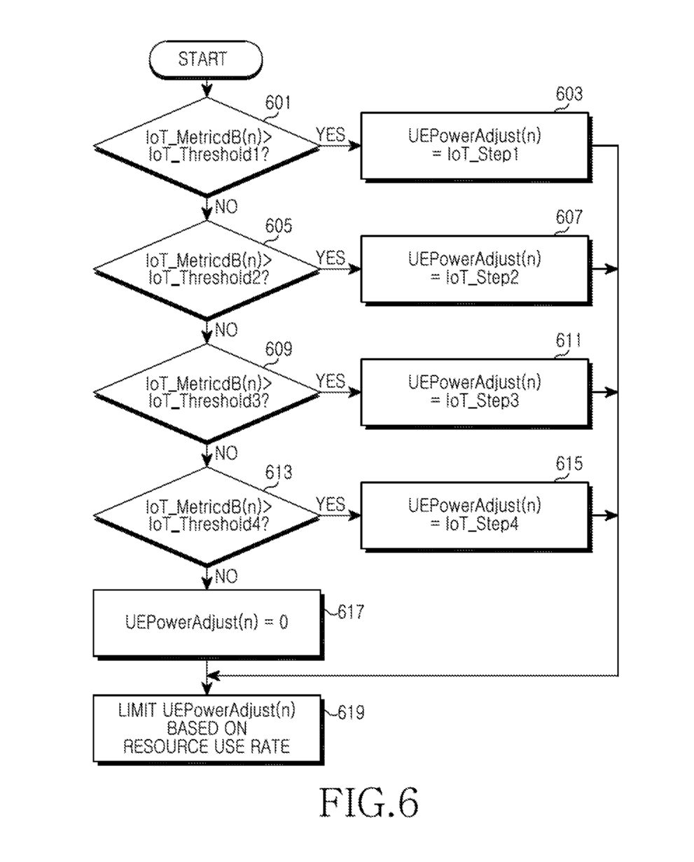

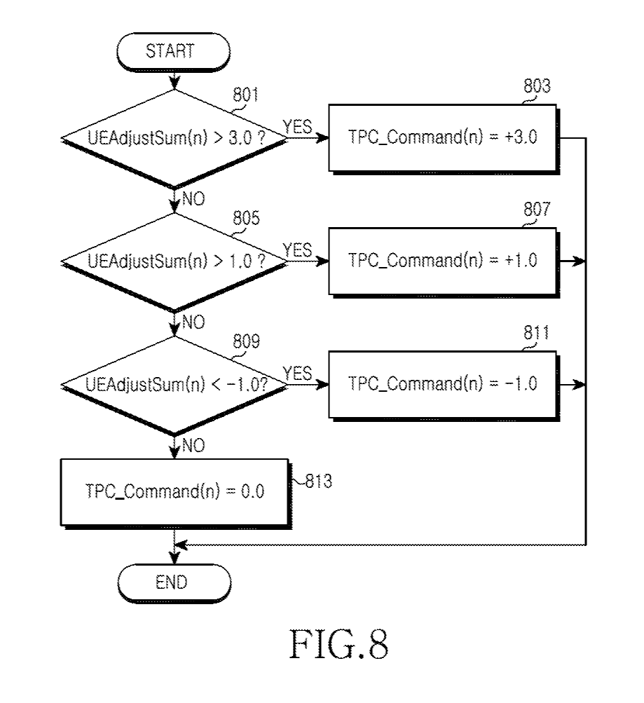

A process for determining the transmit power change based on the IoT_MetricdB of the UE is described in more detail with reference to FIG. 6, and a process for determining the UE transmit power change command based on the cumulative value of the transmit power change of the UE is described in more detail with reference to FIG. 8.

Meanwhile, in an exemplary implementation, before determining the UE transmit power change UEPowerAdjust(n) using the determined IoT_MectricdB(n) in step 111, the BS may limit the UEPowerAdjust(n) according to the MCS level of the UE in step 109. After determining the UE transmit power change UEPowerAdjust(n) using the determined IoT_MectricdB(n) in step 111, the BS may limit the UEPowerAdjust(n) according to the resource use rate in step 113. In other words, when the UE applies the minimum MCS level, the transmit power of the UE is not lowered further as an exception. When the UE applies the maximum MCS level, the transmit power of the UE is not raised further as an exception. When it is necessary to increase the transmit power of the UE and the resource use rate of the BS falls below a certain level, that is, when the RB available for the data packet is not fully used and left, the transmit power of the UE is not raised.

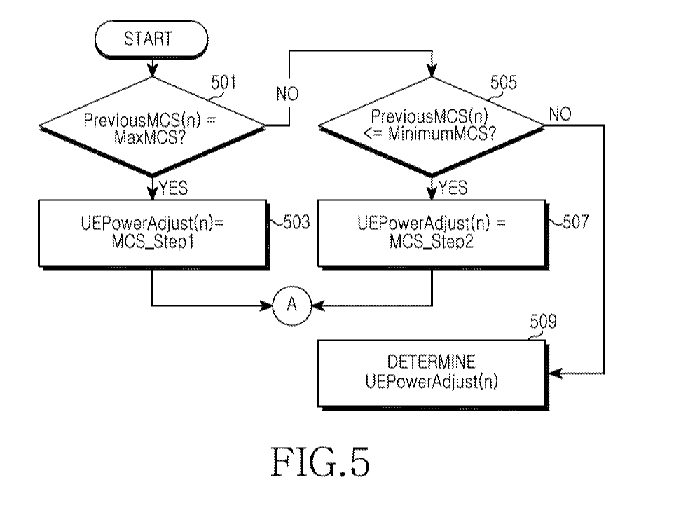

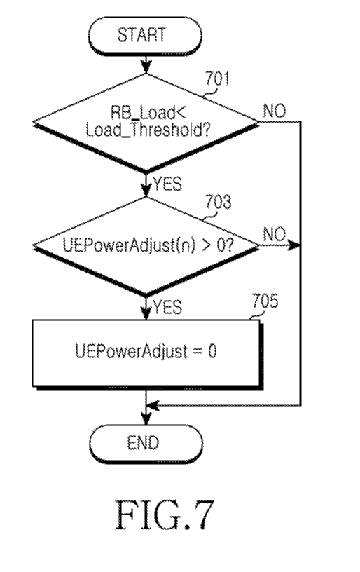

FIG. 5 illustrates a process for limiting the UEPowerAdjust(n) based on the MCS level of the UE, and FIG. 7 illustrates a process for limiting the UEPowerAdjust(n) based on the resource use rate.

FIG. 2 is a flowchart for determining Ol_Weight_dB using a RoT value received from the neighbor BS in a wireless mobile communication system according to an exemplary embodiment of the present invention.

The Ol_Weight_dB(i) is managed by the BS per neighbor cell and its unit is dB.

Referring to FIG. 2, Received_Ol(i) denotes the RoT value received in the neighbor cell i, a current Received_Ol denotes RoT information most recently received in the neighbor cell, and a previous Received_Ol denotes neighbor cell RoT information available in the previous interference cancellation period.

When the neighbor cell RoT value of the current period is greater than a reference value Ol_Weight_UP in step 201 and the neighbor cell RoT value Received_Ol of the previous period is greater than the reference value Ol_Weight_UP in step 203, the BS increases Ol_Weight_dB by a first step Ol_Step1 in step 207.

When the neighbor cell RoT value of the current period is less than the reference value Ol_Weight_UP in step 201, the Received_Ol of the current period is less than a reference value Ol_Weight_Down in step 205, and the Received_Ol of the previous period is less than the reference value Ol_Weight_Down in step 211, the BS decreases the Ol_Weight_dB by the first step Ol_Step1 in step 213.

When the neighbor cell RoT value Received_Ol of the previous period is less than the reference value Ol_Weight_UP in step 203, the Received_Ol of the current period is greater than the reference value Ol_Weight_Down in step 205, or the Received_Ol of the previous period is greater than the reference value Ol_Weight_Down in step 211, the BS proceeds to step 215. When Ol_Weight_dB is greater than or equal to zero (when Ol_Weight_dB is a positive value) in step 209, the BS decreases the Ol_Weight_dB by a second step Ol_Step2 in step 215. When Ol_Weight_dB is less than zero (when Ol_Weight_dB is a negative value), the BS increases the Ol_Weight_dB by the second step Ol_Step2 in step 217.

Next, when the Ol_Weight_dB is greater than or equal to Ol_WeightMaxdB (the maximum of the Ol_Weight_dB) in step 219, the BS sets the Ol_Weight_dB value to the Ol_WeightMaxdB in step 221.

When the Ol_Weight_dB is less than the Ol_WeightMaxdB (the maximum of the Ol_Weight_dB), the BS proceeds to step 223. When the Ol_Weight_dB is less than or equal to Ol_WeightMindB (the minimum of the Ol_Weight_dB), the BS sets the Ol_Weight_dB value to the Ol_WeightMindB in step 225.

In contrast, when the Ol_Weight_dB lies between the Ol_WeightMaxdB and the Ol_WeightMindB, the BS maintains the increased/decreased Ol_Weight_dB value.

As such, in FIG. 2, when the RoT of the neighbor cell is greater than or less than the reference value during two interference cancellation periods, the BS increases or decreases the Ol_Weight_dB by the first step Ol_Step1. In a case where this condition is not satisfied, the Ol_Weight_dB is decreased by the second step Ol_Step2 when the Ol_Weight_dB is the positive value, and the Ol_Weight_dB is increased by the second step Ol_Step2 when the Ol_Weight_dB is the negative value. The maximum and the minimum of the Ol_Weight_dB are set to the Ol_WeightMaxdB and the Ol_WeightMindB, respectively.

FIG. 3 is a flowchart for determining a neighbor cell around a BS using neighbor cell downlink path loss information reported from a UE in a wireless mobile communication system according to an exemplary embodiment of the present invention.

Referring to FIG. 3, the BS does not know information of the neighbor cell until the UE reports of the downlink information of the neighbor cell, and may determine which BS is around itself using the neighbor cell downlink information reported from the UEs accessing the cell of the BS.

The BS sets the NeighborCount(i) value for the neighbor cell i to zero in step 301, and sets the UE index n to zero in step 303. Herein, the NeighborCount(i) is a variable for counting the number of times the UE receives a downlink signal of the neighbor cell i and reports to the BS.

In step 305, the BS determines whether downlink information of the serving cell and the neighbor cell is reported from the n-th UE. The BS increases the NeighborCount(i) value of the n-th UE by one in step 305 and proceeds to step 309.

In contrast, when the downlink of the serving cell and the neighbor cell is not reported from the n-th UE in step 305, the BS determines whether there remains the UE which will report the downlink information of the serving cell and the neighbor cell in step 309. If it is determined that the UE which will report the downlink information of the serving cell and the neighbor cell still remains, the BS increases the value n by one in step 311 and performs the step 307 for a next UE.

The BS may determine its neighbor cell based on the report of the UEs currently accessing the BS, or based on the reports of not only the accessing UE but also the UEs previously accessed.

In step 313, the BS sets the NeighborCell list of the UEs by orderly arranging the downlink information of the neighbor cell reported most by the UEs.

FIG. 4 is a flowchart for determining a path loss between a corresponding UE and a neighbor cell using a neighbor cell list formed based on neighbor cell downlink path loss information reported by the UE in a wireless mobile communication system according to an exemplary embodiment of the present invention.

The UE_NeighborCell list in FIG. 3 is a table including neighbor cell IDs for NeighborMax-ary neighbor cells and path loss information between the corresponding UE and the corresponding cell. Herein, the NeighborMax denotes the maximum number of the neighbor cells included in the UE_NeighborCell list.

Referring to FIG. 4, in step 401, the BS arranges NeighborCell PathlossdB values reported from the UE in an ascending order or in a descending order in the UE_NeighborCell list set in FIG. 3.

In step 403, the BS determines whether the number of the neighbor cells of the set UE_NeighborCell list is greater than or equal to a maximum number of the neighbor cells NeighborMax.

If it is determined that the number of the neighbor cells reported by the UE is greater than or equal to the NeighborMax, the BS proceeds to step 407. The BS stores the neighbor cells reported by the corresponding UE, to the NeighborCell list by the NeighborMax in the ascending order of the path loss.

In contrast, if it is determined that the number of the neighbor cells reported by the UE is less than the NeighborMax, the BS stores the neighbor cell reported by the UE to the current UE_NeighborCell list, and selects and adds an IDentification (ID) of the neighbor cell not included to the current UE_NeighborCell list among the neighbor cells of the previous UE_NeighborCell list to the current_NeighborCell list in step 405.

In step 407, the BS sets list_index=0, K=0, and tempGainSum=0, where K is a variable for counting the neighbor cells without path loss information, list_index is a variable for counting the neighbor cells in the current NeighborCell list, and tempGainSum is a variable for accumulating the path loss of the neighbor cell.

In step 409, the BS determines whether there exists a path loss of the neighbor cell corresponding to the list_index. Upon detecting the path loss of the neighbor cell corresponding to the list_index, the BS accumulates the path loss value of the neighbor cell corresponding to the list_index to the tempGainSum in step 411. In contrast, if it is determined that there is no path loss of the neighbor cell corresponding to the list_index, the BS increases the value K by one in step 413.

In step 415, the BS determines whether the NeighborCell list includes the neighbor cell ID. If it is determined that the neighbor cell ID remains in the NeighborCell list, the BS increases the list_index by one in step 417.

In step 419, the BS estimates the path loss value of the neighbor cell without path loss information, using the number K of the neighbor cells without path loss information and a downlink Channel Quality Indicator CQI reported by the UE.

That is, when the current UE_NeighborCell list lacks the neighbor cell information, the BS constitutes the NeighborMax-ary neighbor cell information at maximum by including the neighbor cell information of the previous UE_NeighborCell list. However, by adding the neighbor cell ID not reported by the UE to the current UE_NeighborCell list, the BS cannot know the path loss information corresponding to the neighbor cell ID not reported by the UE. The path loss information is obtained using the downlink CQI reported by the UE. First, the BS selects the neighbor cell having the path loss information from the NeighborMax-ary neighbor cell information stored to the UE_NeighborCell list of the UE, stores the corresponding path loss information to the tempGainSum, and determines the path loss information of the neighbor cell without path loss information using the number K of the neighbor cells without path loss information based on equation 4.

UE_NeighborCell_PathlossdB(list_index)=−10.0*log₁₀(10^{((-ServingCellPathLossdB(n)-DLCINRdB(n))/10-tempGainSum)/K}) (4)

In equation 4, ServingCellPathLossdB(n) denotes the path loss of the serving cell reported by the UE n, DLCLINE(n) denotes the downlink CINR value reported from the UE n to the BS, tempGainSum denotes a cumulative value of the path loss values in the UE_NeighborCell list, and K denotes the number of the neighbor cells without path loss information in the UE_NeighborCell list.

FIG. 5 is a flowchart for limiting the transmit power change according to a Modulation and Coding Scheme (MCS) level of a UE in a wireless mobile communication system according to an exemplary embodiment of the present invention.

Referring to FIG. 5, when PreviousMCS(n) for the UE n is a maximum MCS level MaxMCS in step 501, the BS decreases the transmit power of the UE by MCS_Step1 by setting UEPowerAdjust(n)=MCS_Step1 in step 503 because there is no need to further raise the transmit power of the UE. Herein, the MCS_Step1 is a negative value in the dB unit. The PreviousMCS(n) is an MCS level most recently assigned to the UE n.

In contrast, when the PreviousMCS(n) is not the maximum MCS level MaxMCS and the PreviousMCS(n) is less than or equal to a preset minimum MCS level MinimumMCS in step 505, the BS raises the transmit power of the UE by MCS_Step2 which is a positive dB value in step 507.

When the MCS level of the UE is neither the maximum nor the minimum, the BS determines the UEPowerAdjust(n) in step 509 (step 111 of FIG. 1).

FIG. 6 is a flowchart for determining the transmit power change according to IoT_MetricdB of a UE in a wireless mobile communication system according to an exemplary embodiment of the present invention.

Referring to FIG. 6, when the IoT_MetricdB(n) is greater than IoT_Threshold1 in step 601, the BS sets UEPowerAdjust(n)=IoT_Step1 in step 603.

When the IoT_MetricdB(n) is not greater than the IoT_Threshold1 in step 601 and the IoT_MetricdB(n) is greater than IoT_Threshold2 in step 605, the BS sets UEPowerAdjust(n)=IoT_Step2 in step 607.

When the IoT_MetricdB(n) is not greater than the IoT_Threshold2 in step 605 and the IoT_MetricdB(n) is greater than IoT_Threshold3 in step 609, the BS sets UEPowerAdjust(n)=IoT_Step3 in step 611.

When the IoT_MetricdB(n) is not greater than the IoT_Threshold3 in step 609 and the IoT_MetricdB(n) is greater than IoT_Threshold4 in step 613, the BS sets UEPowerAdjust(n)=IoT_Step4 in step 615.

When the IoT_MetricdB(n) is not greater than IoT_Threshold4 in step 613, the BS sets UEPowerAdjust(n)=0 in step 617.

Herein, IoT_Threshold1>IoT_Threshold2>IoT_Threshold3>IoT_Threshold3 is satisfied.

In step 619, the BS limits the UEPowerAdjust(n) according to the resource use rate (step 113 of FIG. 1).

As such, to determine the transmit power change UEPowerAdjust(n) of the UE using the IoT_MetricdB(n) of each UE, the transmit power of the UE is decreased when the IoT_MetricdB(n) is greater than the threshold and increased when the IoT_MetricdB(n) is less than the threshold. When the IoT_MetricdB(n) is neither greater nor less than a certain threshold, the transmit power of the UE is not changed by setting UEPowerAdjust(n)=0.

While four thresholds are exemplified in FIG. 6, more than 4 thresholds or less than four thresholds may also be applied.

FIG. 7 is a flowchart for limiting a transmit power change of the UE according to a resource use rate RB_load of a BS in a wireless mobile communication system according to an exemplary embodiment of the present invention.

As allocating the resource to the UE, the BS does not need to increase the transmit power of the UE when the resource use rate falls below a certain level.

Referring to FIG. 7, when the RB_Load is lower than Load_Threshold in step 701, the BS determines whether the transmit power change UEPowerAdjust(n) of the UE is greater than zero in step 703.

If it is determined that the UEPowerAdjust(n) is a positive value in step 703, the BS sets UEPowerAdjust(n)=0 in step 705.

When the RB_Load is greater than the Load_Threshold in step 701 or if it is determined that the transmit power change UEPowerAdjust(n) of the UE is a negative value, the transmit power change of the UE is applied as it is regardless of the resource use rate RB_Load.

FIG. 8 is a flowchart for determining a UE transmit power change command according to a cumulative value of the transmit power change of the UE in a wireless mobile communication system according to an exemplary embodiment of the present invention.

Referring to FIG. 8, when UEAdjustSum(n)>3.0 in step 801, the BS sets TPC_Command(n)=+3.0 in step 803.

When UEAdjustSum(n)≦3.0 in step 801 and UEAdjustSum(n)>1.0 in step 805, the BS sets TPC_Command(n)=+1.0 in step 807.

When UEAdjustSum(n)≦1.0 in step 805 and UEAdjustSum(n)<−1.0 in step 809, the BS sets TPC_Command(n)=−1.0 in step 811.

When UEAdjustSum(n)≧−1.0 in step 809, the BS sets TPC_Command(n)=0.0 in step 813.

The period of the BS for determining the transmit power change of the UE may differ from the period of the BS for giving the transmit power command to the UE. In general, the period for determining the transmit power change is longer. Even when the transmit power change is determined, the transmit power change command may not be issued to the UE but be awaited in an actual situation. Accordingly, while the UEAdjustSum(n) value is being managed per UE as illustrated in FIG. 8, when the transmit power command is issued to the UE, the BS sustains its intended transmit power magnitude of the UE by subtracting the transmit power change transmitted to the UE from the UEAdjustSum(n).

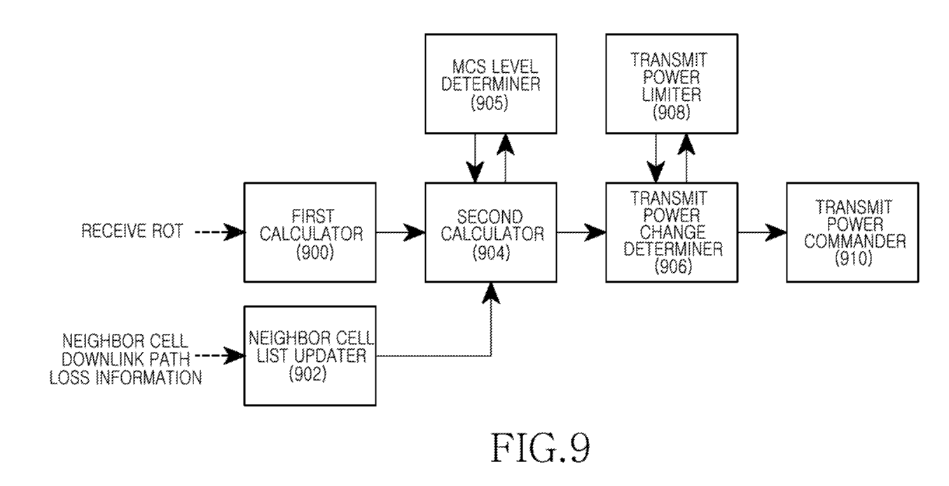

FIG. 9 is a block diagram of a BS for cancelling an uplink interference by determining a transmit power change of a UE in a wireless mobile communication system according to an exemplary embodiment of the present invention.

Referring to FIG. 9, the BS includes a first calculator 900, a neighbor cell list updater 902, a second calculator 904, an MCS level determiner 905, a transmit power change determiner 906, a transmit power limiter 908, and a transmit power commander 910. FIG. 9 is a function block diagram of the BS for cancelling the uplink interference. In the exemplary embodiment of the present invention, other function block diagrams such as transmitter and receiver will be omitted for a better understanding of the BS.

The first calculator 900 receives the RoT value of the neighbor cells over a backbone network and updates the RoT value (i.e., Ol_Weight_dB) of the neighbor cells by comparing them with the RoT value of the previous neighbor cells. During two interference cancellation periods, when the RoT of the neighbor cell is greater or less than a reference value, the first calculator 900 increases or decreases the Ol_Weight_dB by the Ol_Step1. When this condition is not satisfied, the first calculator 900 decreases the Ol_Weight_dB by the Ol_Step2 for the positive Ol_Weight_dB, and increases the Ol_Weight_dB by the Ol_Step2 for the negative Ol_Weight_dB. A maximum and a minimum of the Ol_Weight_dB are set to Ol_WeightMaxdB and Ol_WeightMindB respectively.

The neighbor cell list updater 902 updates the neighbor cell list UE_NeighborCell(n) of the UE using the downlink path loss value reported from the UE. In more detail, each UE measures the downlink path loss of not only its serving BS but also the neighbor BS, and reports the measured downlink path loss to the BS. Using the downlink path loss information, the BS manages the neighbor cell list UE_NeighborCell(n) for each UE. Using the neighbor cell downlink path loss measurement information reported by the corresponding UE and a downlink CQI, the neighbor cell list stores the neighbor cell index expected to exert considerable uplink interference of each UE, and the uplink path loss to the corresponding cell.

To update the neighbor cell list UE_NeighborCell(n), the neighbor cell list updater 902 counts a number of the neighbor cell downlink information reports of the UE accessing the cell of the BS, and constitutes the neighbor cell list based on the number of the counts. The neighbor cell list updater 902 constitutes the path loss information for the NeighborMax-ary cells in the neighbor cell list. More specifically, when the current UE_NeighborCell list lacks the neighbor cell information, the neighbor cell list updater 902 constitutes the NeighborMax-ary neighbor cell information at maximum by including the neighbor cell information of a previous UE_NeighborCell list. Yet, as the neighbor cell ID unreported by the UE is added to the current UE_NeighborCell list, the BS does not know the path loss information corresponding to the neighbor cell ID unreported by the UE. This path loss information is obtained using the downlink CQI reported by the UE. The BS selects the neighbor cell having the path loss information from the NeighborMax-ary neighbor cell information stored to the UE_NeighborCell list of the UE, stores the corresponding path loss information to tempGainSum, and determines the path loss information of the neighbor cell without path loss information using the number K of the neighbor cells without path loss information based on equation 4.

Using the neighbor cell downlink path loss information of the UE stored to the neighbor cell list updater 902, the second calculator 904 estimates an interference magnitude exerted by the UE on the neighbor cell and determines the difference (hereafter, referred to as IoT_MetricdB(n)) between an estimated interference and a target interference of the BS. When the IoT_MetricdB(n) is greater than 0 dB, the second calculator 904 determines that the corresponding UE exerts the interference greater than the target on the neighbor cell. Conversely, when the IoT_MetricdB(n) is less than 0 dB, the second calculator 904 determines that the corresponding UE exerts the interference less than the target on the neighbor cell. The IoT_MetricdB is given by equation 3.

The MCS level determiner 905 restricts the transmit power change according to a current MCS level assigned to the UE. For instance, when the UE uses a minimum MCS level, the transmit power of the UE is not lowered further as an exception. When the UE uses a maximum MCS level, the transmit power of the UE is not raised further as an exception.

The transmit power change determiner 906 determines the UE transmit power change UEPowerAdjust(n) using the IoT_MetricdB(n) determined by the second calculator 904. For example, when the IoT_MetricdB(n) is greater than the threshold, the transmit power change determiner 906 decreases the transmit power of the UE. Conversely, when the IoT_MetricdB(n) is less than the threshold, the transmit power change determiner 906 increases the transmit power. When the IoT_MetricdB(n) is neither greater nor less than the specific threshold, the transmit power change determiner 906 does not adjust the transmit power of the UE by setting UEPowerAdjust(n)=0.

Since it is unnecessary to increase the transmit power of the UE in the resource allocation to the UE when a resource use rate falls below the certain level, the transmit power limiter 908 limits the transmit power change of the UE according to the resource use rate RB_Load. Even when the transmit power of the UE needs to be raised as determined by the transmit power change determiner 906 and the resource use rate of the BS falls below a certain level, that is, when the RB available to the data packet is not used thoroughly and is left, the transmit power limiter 908 does not increase the transmit power of the UE.

The period of the BS for scheduling the data packet and transmitting the command to adjust the transmit power of the UE to each UE may not match the period for determining the transmit power change of the UE for an interference cancellation. Thus, the transmit power commander 910 determines UEPowerAdjustSum(n) by accumulating UEPowerAdjust(n) from the transmit power change determiner 906. In more detail, the transmit power commander 910 accumulates and manages the UEPowerAdjustSum(n) by determining the transmit power UEPowerAdjust(n) of the UE when the UE transmit power change period comes, and subtracts and manages the change commanded to the UE from the UEPowerAdjustSum(n) when the command instructing to adjust the transmit power is issued to the UE.

As described above, by determining the transmit power of the UE using headroom information transmitted from the UE to the BS, the downlink path loss to the serving BS and the neighbor BS, the downlink CQI, and the RoT information received from the neighbor cell, the cell coverage is maintained by maintaining the interference exerted on the neighbor cell at a proper level and the average data rate is enhanced.

While the present has been shown and described with reference to certain exemplary embodiment thereof, it will be understood by those skilled in the art that various changes in form and details may be made therein without departing from the spirit and scope of the invention as defined by the appended claims and their equivalents.

What is claimed is:

1. A method for cancelling uplink interference in a wireless mobile communication system, the method comprising:
estimating interference to be exerted by each User Equipment (UE) on a plurality of neighbor cells based on a Rise over Thermal (RoT) level for the plurality of the neighbor cells;
determining a transmit power variation for each UE based on the estimated interference to be exerted on the neighbor cells; and
transmitting the transmit power variation for the UE to each UE.

2. The method of claim 1, wherein the estimating of the interference to be exerted on the neighbor cells based on the RoT level for the neighbor cells comprises:
after obtaining RoTs of the plurality of the neighbor cells, determining a weight for the RoT of the neighbor cells by comparing the RoT of the neighbor cells with RoTs of previous neighbor cells;
determining a neighbor cell list by receiving channel information reported from the UEs; and
determining an interference level to exert by the UE to the neighbor cell using at least one of path loss information of the neighbor cell in the neighbor cell list and a weight for the RoT of the neighbor cells.

3. The method of claim 2, wherein the determining of the weight for the RoTs of the neighbor cells comprises:
when the neighbor cell RoT value of a current period is greater than a first reference value and the neighbor cell RoT value of a previous period is greater than the first reference value, increasing the weight for the RoT of the neighbor cells by a first step,
when the neighbor cell RoT value of the current period is less than the first reference value, when the neighbor cell RoT value of the current period is less than a second reference value, and when the neighbor cell RoT value of the previous period is less than the second reference value, decreasing the weight for the RoT of the neighbor cells by the first step, and
when the neighbor cell RoT value of the current period is greater than the first reference value and the neighbor cell RoT value of the previous period is less than the first reference value, when the neighbor cell RoT value of the current period is less than the first reference value and greater than the second reference value, and when the neighbor cell RoT value of the current period is less than the first reference value and the second reference value and the neighbor cell RoT value of the previous period is greater than the second reference value, determining whether the weight for the RoT for the neighbor cells is a positive value and at least one of decreasing and increasing the weight for the RoT for the neighbor cells by a second step.

4. The method of claim 3, wherein, when the weight for the RoT for the neighbor cells is greater than a preset maximum weight, the weight for the RoT of the neighbor cells is set to the maximum weight, and
when the weight for the RoT of the neighbor cells is less than a preset minimum weight, the weight for the RoT of the neighbor cells is set to the minimum weight.

5. The method of claim 2, wherein the determining of the neighbor cell list comprises:
counting a number of reports on the channel information per UE;
setting the neighbor cell list based on the number of the channel information reports; and
updating the neighbor cell list by comparing a number of neighbor cells in the set neighbor cell list with a maximum allowable number of neighbor cells.

6. The method of claim 5, wherein the updating of the neighbor cell list by comparing the number of the neighbor cells in the set neighbor cell list with the maximum allowable number of the neighbor cells comprises:
when the number of the neighbor cells in the set neighbor cell list is smaller than the maximum allowable number of the neighbor cells, setting the number of the neighbor cells in the set neighbor cell list equal to the maximum allowable number of the neighbor cells, by including neighbor cells not contained in the set neighbor cell list among the neighbor cells of a previous neighbor cell list, to the set neighbor cell list.

7. The method of claim 6, wherein the path loss for the neighbor cells of the previous cell list in the set neighbor cell list is determined based on the following equation:
UE_NeighborCell_PathlossdB(list_index)=−10.0*log₁₀(10^{((-ServingCellPathLossdB(n)-DLCINRdB(n))/10-tempGainSum)/K})
where ServingCellPathLossdB(n) denotes the path loss of a serving cell reported by a UE n, DLCLINE(n) denotes a downlink Carrier-to-Interference-and-Noise Ratio (CINR) value reported from the UE n to a BS, tempGainSum denotes a cumulative value of the path loss values in UE_NeighborCell list, and K denotes the number of the neighbor cells without path loss information in the UE_NeighborCell list.

8. The method of claim 5, wherein, when the number of the neighbor cells in the set neighbor cell list is at least one of greater than and equal to the maximum allowable number of the neighbor cells, the number of the neighbor cells in the set neighbor cell list is adjusted by the maximum allowable number of the neighbor cells.

9. The method of claim 2, wherein the channel information comprises at least one of a Channel Quality Indicator (CQI) and downlink path loss information between the cell and the UE.

10. The method of claim 2, wherein the interference level exerted by each UE on the neighbor cell is determined based on the following equation:
$$IoT\_MetricdB ( n ) = {( {\sum }_{i}^{for all UE NeighborCell} {( IoT\_MetricdB ( n , i ) )}_{linear} )}_{d B}$$
$$IoT\_MetricdB ( n , i ) = OI\_WeightdB ( i ) + CurrentTxPowerdBm ( n ) - ( RBNo + 10 \times {log}_{10} ( {10}^{( IoTTargetedB / 10 )} - 1 ) ) + CINRfactor \times CINRdB ( n ) - NeighborPathlossdB ( n , i )$$
where OI_WeightdB(i) denotes the weight for the RoT of the neighbor cell, CurrentTxPowerdBm(n) denotes a transmit power per resource of each UE, RBNo denotes a power magnitude of thermal noise per resource, IoTT arg etdB denotes a target interference magnitude, CINRdB(n) denotes a CINR received at the BS when each UE transmits a data packet, CINRfactor denotes a constant value indicating a rate of applying CINRdB(n) to IoT_MetricdB(n,i), and NeighborPathlossdB(n,i) denotes the path loss of the UE n and the neighbor cell i.

11. The method of claim 1, wherein the determining of the transmit power variation for each UE based on the estimated interference to be exerted on the neighbor cells compares the interference level exerted by each UE on the neighbor cell with at least one threshold,
decreases the transmit power of the UE by a predefined step when the interference level exerted by each UE on the neighbor cell is greater than the at least one threshold,
increases the transmit power of the UE by a predefined step when the interference level exerted by each UE on the neighbor cell is less than the at least one threshold, and
sets the transmit power variation to zero when the interference level exerted by each UE on the neighbor cell is less than each of the at least one threshold.

12. The method of claim 11, wherein, when a Modulation and Coding Scheme (MCS) level assigned to the UE is a maximum MCS level, the transmit power for the UE is not increased further, and
when the MCS level assigned to the UE is a minimum MCS level, the transmit power for the UE is not lowered further.

13. The method of claim 11, wherein, when a current resource use rate is less than a threshold and the transmit power variation is at least one of increased and decreased, the transmit power variation for the UE is set to zero.

14. The method of claim 11, further comprising:
accumulating the transmit power variation for the UE per UE.

15. An apparatus of a Base Station (BS) for cancelling uplink interference in a wireless mobile communication system, the apparatus comprising:
the BS for estimating interference to be exerted by User Equipments (UEs) on a plurality of neighbor cells based on a Rise over Thermal (RoT) level for the plurality of the neighbor cells, for determining a transmit power change for each UE based on the estimated interference to be exerted on the plurality of the neighbor cells, and for transmitting the transmit power variation for the UE to each UE.

16. The apparatus of claim 15, wherein, to estimate the interference to be exerted by the UEs on the plurality of neighbor cells considering the RoT level for the plurality of the neighbor cells, the BS comprises:
a first calculator for, after obtaining RoTs of the neighbor cells, determining a weight for the RoT of the neighbor cells by comparing with RoTs of previous neighbor cells;
a neighbor cell list updater for determining a neighbor cell list by receiving channel information reported from the UEs; and
a second calculator for determining an interference level exerted by the UE on the neighbor cell using at least one of path loss information of the neighbor cell in the neighbor cell list and a weight for the RoT of the neighbor cells.

17. The apparatus of claim 16, wherein, when the neighbor cell RoT value of a current period is greater than a first reference value and the neighbor cell RoT value of a previous period is greater than the first reference value, the first calculator increases the weight for the RoT of the neighbor cells by a first step,
when the neighbor cell RoT value of the current period is less than the first reference value, the neighbor cell RoT value of the current period is less than a second reference value, and the neighbor cell RoT value of the previous period is less than the second reference value, the first calculator decreases the weight for the RoT of the neighbor cells by the first step, and
when the neighbor cell RoT value of the current period is greater than the first reference value and the neighbor cell RoT value of the previous period is less than the first reference value, when the neighbor cell RoT value of the current period is less than the first reference value and greater than the second reference value, and when the neighbor cell RoT value of the current period is less than the first reference value and the second reference value and the neighbor cell RoT value of the previous period is greater than the second reference value, the first calculator determines whether the weight for the RoT for the neighbor cells is a positive value and at least one of decreases and increases the weight for the RoT for the neighbor cells by a second step.

18. The apparatus of claim 17, wherein, when the weight for the RoT of the neighbor cells is greater than a preset maximum weight, the first calculator sets the weight for the RoT of the neighbor cells to the maximum weight, and
when the weight for the RoT of the neighbor cells is less than a preset minimum weight, the first calculator sets the weight for the RoT of the neighbor cells to the minimum weight.

19. The apparatus of claim 16, wherein the neighbor cell list updater counts a number of reports on the channel information per UE, sets the neighbor cell list by arranging based on the number of the channel information reports, and updates the neighbor cell list by comparing a number of neighbor cells in the set neighbor cell list with a maximum allowable number of neighbor cells.

20. The apparatus of claim 19, wherein, when the number of the neighbor cells in the set neighbor cell list is smaller than the maximum allowable number of the neighbor cells, the neighbor cell list updater sets the number of the neighbor cells in the set neighbor cell list equal to the maximum allowable number of the neighbor cells, by including neighbor cells not contained in the set neighbor cell list among the neighbor cells of a previous neighbor cell list, to the set neighbor cell list.

21. The apparatus of claim 19, wherein the path loss for the neighbor cells of the previous cell list in the set neighbor cell list is determined based on the following equation:
UE_NeighborCell_PathlossdB(list_index)=−10.0*log₁₀(10^{((-ServingCellPathLossdB(n)-DLCINRdB(n))/10-tempGainSum)/K})
where ServingCellPathLossdB(n) denotes the path loss of a serving cell reported by a UE n, DLCLINE(n) denotes a downlink Carrier-to-Interference-and-Noise Ratio (CINR) value reported from the UE n to a BS, tempGainSum denotes a cumulative value of the path loss values in UE_NeighborCell list, and K denotes the number of the neighbor cells without path loss information in the UE_NeighborCell list.

22. The apparatus of claim 19, wherein, when the number of the neighbor cells in the set neighbor cell list is at least one of greater than and equal to the maximum allowable number of the neighbor cells, the number of the neighbor cells in the set neighbor cell list is adjusted by the maximum allowable number of the neighbor cells.

23. The apparatus of claim 16, wherein the channel information comprises at least one of a Channel Quality Indicator (CQI) and downlink path loss information between the cell and the UE.

24. The apparatus of claim 16, wherein the interference level exerted by each UE on the neighbor cell is determined based on the following equation:
$$IoT\_MetricdB ( n ) = {( {\sum }_{i}^{for all UE NeighborCell} {( IoT\_MetricdB ( n , i ) )}_{linear} )}_{d B}$$
$$IoT\_MetricdB ( n , i ) = OI\_WeightdB ( i ) + CurrentTxPowerdBm ( n ) - ( RBNo + 10 \times {log}_{10} ( {10}^{( IoTTargetedB / 10 )} - 1 ) ) + CINRfactor \times CINRdB ( n ) - NeighborPathlossdB ( n , i )$$
where OI_WeightdB(i) denotes the weight for the RoT of the neighbor cell, CurrentTxPowerdBm(n) denotes a transmit power per resource of each UE, RBNo denotes a power magnitude of thermal noise per resource, IoTT arg etdB denotes a target interference magnitude, CINRdB(n) denotes a CINR received at the BS when each UE transmits a data packet, CINRfactor denotes a constant value indicating a rate of applying CINRdB(n) to IoT_MetricdB(n,i), and NeighborPathlossdB(n,i) denotes the path loss of the UE n and the neighbor cell i.

25. The apparatus of claim 15, wherein the BS comprises:
a transmit power variation determiner for, to determine the transmit power variation for each UE based on the estimated interference to be exerted on the neighbor cells, comparing the interference level to be exerted by each UE on the neighbor cell with at least one threshold, for decreasing the transmit power of the UE by a predefined step when the interference level to be exerted by each UE on the neighbor cell is greater than the at least one threshold, for increasing the transmit power of the UE by a predefined step when the interference level to be exerted by each UE on the neighbor cell is less than the at least one threshold, and for setting the transmit power variation to zero when the interference level to be exerted by each UE on the neighbor cell is less than each of the at least one threshold.

26. The apparatus of claim 25, wherein, when a Modulation and Coding Scheme (MCS) level assigned to the UE is a maximum MCS level, the transmit power variation determiner does not further increase the transmit power for the UE, and
when the MCS level assigned to the UE is a minimum MCS level, the transmit power variation determiner does not further decrease the transmit power for the UE.

27. The apparatus of claim 25, wherein the BS comprises:
a transmit power limiter for setting the transmit power variation for the UE to zero, when a current resource use rate is less than a threshold and the transmit power variation is at least one of increased and decreased.

28. The apparatus of claim 25, wherein the BS further comprises:
a transmit power commander for accumulating the transmit power variation for the UE per UE.

29. A method for cancelling uplink interference in a wireless mobile communication system, the method comprising:
determining a weight based on a Rise over Thermal (RoT) level received from a plurality of neighbor cells;
estimating an interference to be exerted by each UE on the neighbor cells using the weight;
determining a transmit power variation for each UE by comparing the estimated interference to be exerted on the neighbor cells with at least one threshold; and
accumulating the transmit power variation for the UE during a transmit command period for the transmit power variation, and transmitting the accumulated transmit power variation to each UE in the transmit command period for the transmit power variation.

30. The method of claim 29, wherein the determining of the weight based on the RoT level received from the neighbor cells comprises:
when the neighbor cell RoT value of a current period is greater than a first reference value and the neighbor cell RoT value of a previous period is greater than the first reference value, increasing the weight for the RoT of the neighbor cells by a first step,
when the neighbor cell RoT value of the current period is less than the first reference value, when the neighbor cell RoT value of the current period is less than a second reference value, and when the neighbor cell RoT value of the previous period is less than the second reference value, decreasing the weight for the RoT of the neighbor cells by the first step, and
when the neighbor cell RoT value of the current period is greater than the first reference value and the neighbor cell RoT value of the previous period is less than the first reference value, when the neighbor cell RoT value of the current period is less than the first reference value and greater than the second reference value, and when the neighbor cell RoT value of the current period is less than the first reference value and the second reference value and the neighbor cell RoT value of the previous period is greater than the second reference value, determining whether the weight for the RoT of the neighbor cells is a positive value and at least one of decreasing and increasing the weight for the RoT of the neighbor cells by a second step.

31. The method of claim 30, wherein, when the weight for the RoT of the neighbor cells is greater than a preset maximum weight, the weight for the RoT of the neighbor cells is set to the maximum weight, and
when the weight for the RoT of the neighbor cells is less than a preset minimum weight, the weight for the RoT of the neighbor cells is set to the minimum weight.

32. The method of claim 29, further comprising:
receiving channel information from each UE and determining a neighbor cell list of the UE.

33. The method of claim 32, wherein the determining of the neighbor cell list of the UE comprises:
counting a number of reports on the channel information per UE;
constituting the neighbor cell list based on the number of the channel information reports; and
updating the neighbor cell list by comparing a number of neighbor cells in the constituted neighbor cell list with a maximum allowable number of neighbor cells.

34. The method of claim 33, wherein, when the number of the neighbor cells in the set neighbor cell list is smaller than the maximum allowable number of the neighbor cells, the updating of the neighbor cell list sets the number of the neighbor cells in the constituted neighbor cell list equal to the maximum allowable number of the neighbor cells, by including previous neighbor cells not contained in the constituted neighbor cell list among the neighbor cells of a previous neighbor cell list, to the constituted neighbor cell list.

35. The method of claim 34, wherein the path loss of the previous cells in the constituted neighbor cell list is determined based on the following equation:
UE_NeighborCell_PathlossdB(list_index)=−10.0*log₁₀(10^{((-ServingCellPathLossdB(n)-DLCINRdB(n))/10-tempGainSum)/K})
where ServingCellPathLossdB(n) denotes the path loss of a serving cell reported by a UE n, DLCLINE(n) denotes a downlink Carrier-to-Interference-and-Noise Ratio (CINR) value reported from the UE n to a BS, tempGainSum denotes a cumulative value of the path loss values in UE_NeighborCell list, and K denotes the number of the neighbor cells without path loss information in the UE_NeighborCell list.

36. The method of claim 34, wherein the number of the neighbor cells in the constituted neighbor cell list is at least one of greater than and equal to the maximum allowable number of the neighbor cells, the number of the neighbor cells in the constituted neighbor cell list is adjusted by the maximum allowable number of the neighbor cells.

37. The method of claim 32, wherein the channel information comprises at least one of a Channel Quality Indicator (CQI) and downlink path loss information between the neighbor cell and the UE.

38. The method of claim 29, wherein the interference exerted by each UE on the neighbor cells is estimated based on the following equation:
$$IoT\_MetricdB ( n ) = {( {\sum }_{i}^{for all UE NeighborCell} {( IoT\_MetricdB ( n , i ) )}_{linear} )}_{d B}$$
$$IoT\_MetricdB ( n , i ) = OI\_WeightdB ( i ) + CurrentTxPowerdBm ( n ) - ( RBNo + 10 \times {log}_{10} ( {10}^{( IoTTargetedB / 10 )} - 1 ) ) + CINRfactor \times CINRdB ( n ) - NeighborPathlossdB ( n , i )$$
where OI_WeightdB(i) denotes the weight for the RoT of the neighbor cell, CurrentTxPowerdBm(n) denotes a transmit power per resource of each UE, RBNo denotes a power magnitude of thermal noise per resource, IoTT arg etdB denotes a target interference magnitude, CINRdB(n) denotes a CINR received at the BS when each UE transmits a data packet, CINRfactor denotes a constant value indicating a rate of applying CINRdB(n) to IoT_MetricdB(n,i), and NeighborPathlossdB(n,i) denotes the path loss of the UE n and the neighbor cell i.

39. The method of claim 29, wherein the determining of the transmit power variation for each UE compares the estimated interference of the UE with at least one threshold, decreases the transmit power of the UE by a predefined step when the estimated interference of the UE is greater than the at least one threshold, increases the transmit power of the UE by a predefined step when the estimated interference of the UE is less than the at least one threshold, and sets the transmit power variation to zero when the estimated interference of the UE is less than all of the at least one threshold.

40. The method of claim 29, further comprising:
when determining the transmit power variation for each UE, limiting the transmit power variation of the UE based on the MCS level assigned to the UE.

41. The method of claim 29, further comprising:
when determining the transmit power variation for each UE, limiting the transmit power variation of the UE based on a resource use rate assigned to the UE,
wherein the transmit power variation for the UE is set to zero when a current resource use rate is less than a threshold and the transmit power variation is at least one of increased and decreased.
